(19) United States
(12) Patent Application Publication
(10) Pub. No.: US 2024/0202744 A1
(43) Pub. Date: Jun. 20, 2024

(54) USING BLOCKCHAIN TECHNOLOGY TO DETERMINE AUTHENTICITY OF ITEMS

(71) Applicant: Capital One Services, LLC, McLean, VA (US)

(72) Inventors: Samuel RAPOWITZ, Roswell, GA (US); Chandra Sekhar Babu NAGAM VENKATA, McLean, VA (US); Fernando A. ALVAREZ, Chesapeake, VA (US); Jeffrey W. EDWARDS, McLean, VA (US)

(73) Assignee: Capital One Services, LLC, McLean, VA (US)

(21) Appl. No.: 18/066,208

(22) Filed: Dec. 14, 2022

(51) Int. Cl. G06Q 30/018; G06Q 20/38; G06Q 20/40

(52) U.S. Cl. CPC G06Q 30/0185; G06Q 20/389; G06Q 20/401; G06Q 2220/00

(57) ABSTRACT

Methods and systems are described herein for verifying authenticity of items using blockchain operations. In particular, an authentication system may be used to perform validation operations. The authentication system may monitor a blockchain (e.g., via a blockchain node) for any blockchain operations to an address of a cryptography-based storage application controlled by the authentication system (e.g., an authentication system maintained by the manufacturer of the item). When the authentication system detects such operation, the authentication system may retrieve an identifier of an item (e.g., a serial number) from the blockchain operation and determine, based on the identifier, whether the item is authentic. The authentication system may then use the source address of the cryptography-based storage application that requested verification and generate another blockchain operation to respond and verify authenticity.

### BACKGROUND

In recent years, bad actors have become increasingly skilled at replicating items and passing them off as genuine. This has been a big problem for both manufacturers and users as users desire to acquire items that are genuine and not replicated. To solve this problem, manufacturers started adding identification tags and numbers to products. A user is able to submit an identification number into a manufacturer's system to determine whether an item is genuine. However, there are various issues with the process. First, this process is unable to efficiently track when items get acquired by one user from another user. In addition, there is no guarantee that a bad actor has not obtained a particular identifier of an item and is adding that identifier to all replicas. Thus, users would like the ability to quickly and efficiently validate that an item is genuine.

### SUMMARY

One mechanism for quickly and efficiently validating that an item is genuine may use blockchain technology and, in particular, blockchain operations. That is, the mechanism may provide item verification and facilitate transfer by adding data to blockchain operations. Therefore, methods and systems are described herein for verifying authenticity of items using blockchain operations. In particular, an authentication system may be used to perform validation operations. The authentication system may monitor a blockchain (e.g., via a blockchain node) for any blockchain operations to a cryptography-based storage application (e.g., a cryptographic wallet) controlled by the authentication system (e.g., an authentication system maintained by the manufacturer of the item). When the authentication system detects such operation, the authentication system may retrieve an identifier of an item (e.g., a serial number) from the blockchain operation and determine based on the identifier whether the item is authentic. The authentication system may then use the source address of the cryptography-based storage application that requested validation and generate another blockchain operation to respond and verify authenticity.

The authentication system may perform the following operations when verifying authenticity of items using blockchain operations. The authentication system may detect a first blockchain operation that transfers control of one or more cryptographic tokens from a first cryptography-based storage application (e.g., a cryptography-based storage application associated with a user attempting to perform verification) to a second cryptography-based storage application (e.g., a cryptography-based storage application associated with an entity able to authenticate the item). The first blockchain operation may store an identifier of an item. For example, a user may want to confirm that a particular watch is authentic. A part of the authentication mechanism may be built into an application on the user's smartphone or on another suitable electronic device. The user may use her smartphone to scan an identifier of the watch (e.g., printed or etched on the watch itself). The application on the user's smartphone may then generate a blockchain operation that moves a small number of cryptographic tokens controlled by the user's cryptography-based storage application to be controlled by the manufacturer's cryptography-based storage application. The authentication system may be scanning the blockchain (e.g., via a blockchain node) for any operations transferring control of cryptographic tokens to the cryptography-based storage application of the manufacturer.

When the authentication system detects the blockchain operation for the cryptography-based storage application it controls, the authentication system may retrieve blockchain operation data associated with the first blockchain operation. For example, the authentication system may query the blockchain node and retrieve data associated with the blockchain operation. The blockchain operation data may include not only the data for transferring control of cryptographic tokens, but also data for authenticating items.

The authentication system may then extract the identifier of the item from the blockchain operation data. For example, the blockchain operation data may include a serial number of a watch that a user is attempting to authenticate. Thus, the authentication system may extract the serial number from the blockchain operation data. In some embodiments, the blockchain operation data may include a flag indicating an operation is requested. For example, the flag may be an indication that a user is requesting verification of the time. Another example may be an indication that the user is requesting transfer of the item to another user. Other data may be added to the blockchain operation and extracted.

The authentication system may then determine, based on the identifier of the item, that the item is authentic. For example, the authentication system may compare the serial number received in the blockchain operation with valid serial numbers in a database. If the serial numbers match, the authentication system may determine that the item is authentic. In some embodiments, the authentication system may use a physical location to further determine whether the item is authentic. In particular, the authentication system may extract, from the blockchain operation data, a first location associated with the first cryptography-based storage application. For example, the authentication system may determine an Internet Protocol (IP) address from which the blockchain operation was requested and determine, based on that IP address, the location of the verifier and by extension the location of the item being authenticated. Furthermore, the authentication system may retrieve, based on the identifier of the item, a second location associated with a third cryptography-based storage application of an entity possessing the item. For example, the authentication system may perform a lookup (e.g., within a database or on a blockchain) of an IP address associated with the last transfer of the item and determine the location associated with the IP address. The authentication system may then compare the first location and the second location and based on determining that the first location matches the second location, determine that the item is authentic. That is, the authentication system may determine that location of the current owner and the location of the verification request match and based on that in combination with a valid identifier (e.g., serial number), determine that the item is genuine.

In some embodiments, the authentication system may take into account a virtual location of the item. For example, the authentication system may determine a first virtual location associated with the first cryptography-based storage application. The first virtual location may be a first identifier of an Internet-based application being accessed by a user. For example, the user may be accessing a decentralized application over the Internet that is able to read the address of the user's cryptography-based storage application. Thus, the blockchain operation may include an Internet address associated with the Internet-based application. The authentication system may also retrieve, based on the identifier of the item, a second virtual location of an entity possessing the item. The second virtual location may be a second identifier of an application hosted by the entity. For example, the authentication system may retrieve from a database or from the blockchain the Internet-based application associated with the current owner. The authentication system may then compare the first virtual location and the second virtual location and based on determining that the first virtual location matches the second virtual location, determine that the item is authentic. Thus, if virtual locations match, the authentication system may determine that the item is authentic.

In some embodiments, the authentication system may keep track of ownership of the item based on blockchain operations associated with the identifier of the item (e.g., a serial number) and may use the owner's cryptography-based storage application address to determine authenticity. Thus, to determine whether the item is authentic, the authentication system may retrieve from the blockchain operation data an address of the cryptography-based storage application from the claimed owner of the item and compare that address with the blockchain operation data retrieved from the blockchain representing the last transfer of the item. If those addresses match, the authentication system may determine that the item is authentic.

When the item is authenticated, the authentication system may, through transfer of the same cryptographic tokens back to the original verifier, inform the verifier whether the item is authentic. In particular, the authentication system may generate a second blockchain operation. The second blockchain operation may transfer control of the one or more cryptographic tokens from the second cryptography-based storage application to the first cryptography-based storage application. The second blockchain operation may store the identifier of the item and an indication that the item is authentic. For example, if the watch is authentic, the authentication system may generate a blockchain operation that includes the serial number and a “YES” indicator. The authentication system may then transmit the second blockchain operation to a blockchain node.

In some embodiments, the authentication system may keep track of ownership of a particular item. Thus, when the item is transferred from one owner to another, the authentication system may generate, based on a request from the owner, a blockchain operation that may indicate a transfer of the serial number. Through these transfer operations, the authentication system may track ownership. In addition, the authentication system may confirm the chain of ownership by retrieving all blockchain operations associated with the identifier of the item (e.g., a serial number of an item).

Various other aspects, features, and advantages of the system will be apparent through the detailed description and the drawings attached hereto. It is also to be understood that both the foregoing general description and the following detailed description are examples, and not restrictive of the scope of the disclosure. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), of a given item (e.g., data), unless the context clearly dictates otherwise.

### BRIEF DESCRIPTION OF THE DRAWINGS

FIG. 1 shows an illustrative system for verifying authenticity using blockchain operations, in accordance with one or more embodiments of this disclosure.

FIG. 2 illustrates a portion of a blockchain operation for verifying authenticity of an item, in accordance with one or more embodiments of this disclosure.

FIG. 3 illustrates a portion of a data structure storing locations, in accordance with one or more embodiments of this disclosure.

FIG. 4 illustrates a portion of a blockchain operation for sending an authenticity verification in response to a request, in accordance with one or more embodiments of this disclosure.

FIG. 5 illustrates a table of possible operations and corresponding encodings, in accordance with one or more embodiments of this disclosure.

FIG. 6 illustrates a computing device, in accordance with one or more embodiments of this disclosure.

FIG. 7 shows an illustrative diagram for a decentralized environment for performing blockchain functions or operations, in accordance with one or more embodiments.

FIG. 8 is a flowchart of operations for verifying authenticity using blockchain operations, in accordance with one or more embodiments of this disclosure.

### DETAILED DESCRIPTION

In the following description, for the purposes of explanation, numerous specific details are set forth in order to provide a thorough understanding of the disclosed embodiments. It will be appreciated, however, by those having skill in the art, that the embodiments may be practiced without these specific details, or with an equivalent arrangement. In other cases, well-known models and devices are shown in block diagram form in order to avoid unnecessarily obscuring the disclosed embodiments. It should also be noted that the methods and systems disclosed herein are also suitable for applications unrelated to source code programming.

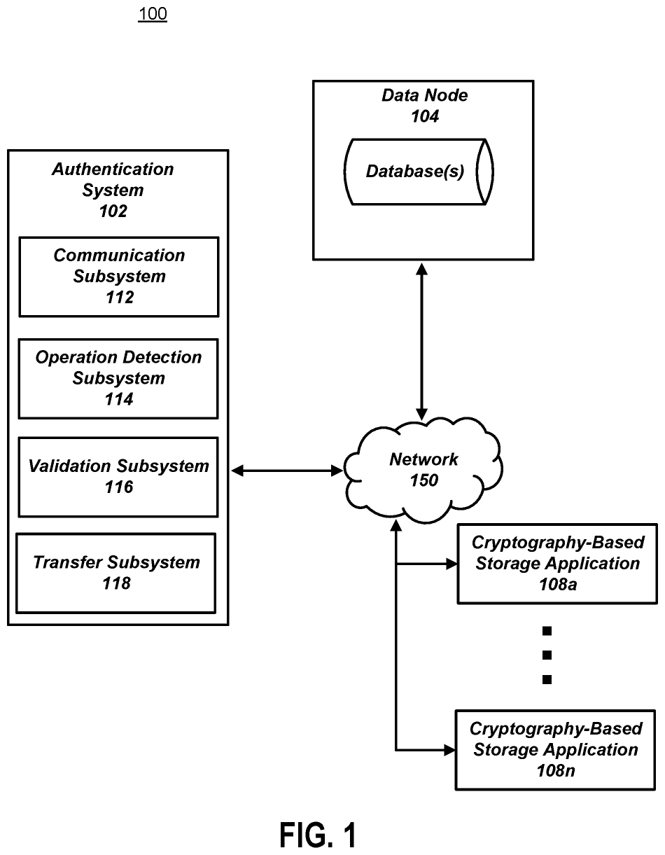

FIG. 1 is an example of environment 100 for verifying authenticity of items using blockchain operations. Environment 100 includes authentication system 102, data node 104, and cryptography-based storage applications 108a-108n. Authentication system 102 may execute instructions for verifying authenticity of items using blockchain operations. Authentication system 102 may include software, hardware, or a combination of the two. For example, authentication system 102 may be hosted on a physical server or a virtual server that is running on a physical computer system. In some embodiments, authentication system 102 may be configured on a user device (e.g., a laptop computer, a smartphone, a desktop computer, an electronic tablet, or another suitable user device). In some embodiments, authentication system 102 may be hosted on a blockchain and may execute operations on a blockchain node. For example, authentication system 102 may be a part of a smart contract or another on-chain program that is being executed by a blockchain node. In some embodiments, authentication system 102 may be hosted on an independent computing device and may send requests to the blockchain node to execute instructions (e.g., retrieve cryptographic tokens, mint cryptographic tokens, etc.).

Each of the cryptography-based storage applications 108a-108n may sometimes be referred to as a cryptographic wallet. Each cryptography-based storage application may store a private key associated with a corresponding user and may include software, hardware, or a combination of the two. For example, each cryptography-based storage application may include software executed on one or multiple devices or may include hardware such as a physical device. In some cases, a cryptography-based storage application may be software and may be stored in data nodes and a user of the cryptography-based storage application may access the cryptography-based storage application online, e.g., via a browser. Alternatively or additionally, a cryptography-based storage application may reside on a general-purpose computer or on a special device (e.g., a fob) intended for storing the cryptography-based storage application. For example, the device may store private keys in a memory of the device and allow transactions to be completed on the device itself. Some examples of hardware cryptographic wallets include Ledger®, and Trezor®. Software cryptographic wallets may include MetaMask® and others.

Data node 104 may store various data, including item data (e.g., serial numbers and/or other item identifiers), ownership data (e.g., blockchain addresses of past and present owners of items), and/or other suitable data. Data node 104 may include software, hardware, or a combination of the two. For example, data node 104 may be a physical server or a virtual server that is running on a physical computer system. In some embodiments, authentication system 102 and data node 104 may reside on the same hardware and/or the same virtual server/computing device. Network 150 may be a local area network, a wide area network (e.g., the Internet), or a combination of the two.

Authentication system 102 may monitor a blockchain (e.g., via a blockchain node) for a blockchain operation directed to a particular blockchain address associated with a cryptography-based storage application controlled by authentication system 102. For example, authentication system 102 may use communication subsystem 112 to poll the blockchain (e.g., via a blockchain node) for new operations. Communication subsystem 112 may include software components, hardware components, or a combination of both. For example, communication subsystem 112 may include a network card (e.g., a wireless network card and/or a wired network card) that is associated with software to drive the card. Thus, authentication system 102 may be configured to trigger various processing functions based on a blockchain operation (e.g., a blockchain transaction) being directed to the blockchain address that authentication system 102 controls.

In one example, a user may want to authenticate a watch or a handbag. The user may use a client device (e.g., a smartphone, electronic tablet, or another suitable device) to connect to an Internet-based application for authenticating the item. The Internet-based application may be part of authentication system 102. In some embodiments, the user may use a browser to connect to the Internet-based application. However, in some embodiments, the Internet-based application may have a client component residing on the user device. Thus, the user (e.g., using the user device) may scan or otherwise input an identifier of the item (e.g., a serial number of the watch or a handbag, or another suitable identifier). The Internet-based application may read an identifier associated with the cryptography-based application of the user (e.g., a blockchain address of the user's cryptographic wallet) and generate a blockchain operation (e.g., a blockchain transaction) that transfers a number (e.g., a small number) of cryptographic tokens to be controlled by a cryptography-based application of the authenticating entity (e.g., to a blockchain address controlled by the manufacturer or another entity enabling authentication). The transaction may serve as a request to authenticate the item.

Authentication system 102 may detect a first blockchain operation that transfers control of one or more cryptographic tokens from a first cryptography-based storage application to a second cryptography-based storage application. In some embodiments, authentication system 102 may receive a notification from, for example, data node 104 when data node 104 analyzes all the blockchain operations received from a blockchain node. The first blockchain operation may store an identifier (e.g., a serial number or another suitable identifier) of an item for authenticity verification. The first cryptography-based storage application may be associated with a client device of a user and the second cryptography-based storage application may be associated with a server. For example, as the authentication system 102 polls the blockchain, authentication system 102 may receive (e.g., via communication subsystem 102) blockchain operations (sometimes referred to as blockchain transactions) from the blockchain. As communication subsystem 112 receives those transactions, communication subsystem 112 may pass the transactions to operation detection subsystem 114. Operation detection subsystem 114 may include software components, hardware components, or a combination of both. For example, operation detection subsystem 114 may include software components that access on-chain data. Operation detection subsystem 114 may scan each transaction for an identifier (e.g., a blockchain address) associated with the cryptography-based storage application controlled by authentication system 102, which may be located in a target field of the blockchain operation.

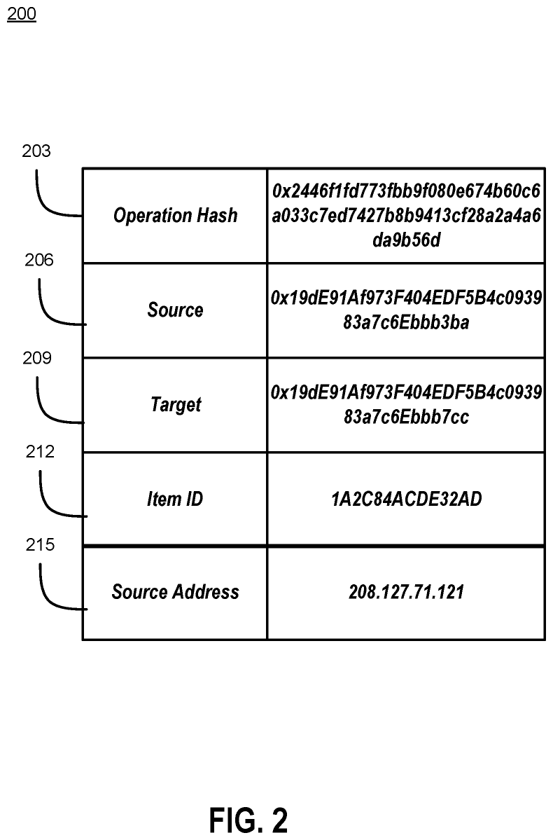

FIG. 2 illustrates a portion of a blockchain operation 200. Each blockchain operation may include a number of parameters or fields. Blockchain operation 200 may include an operation hash 203 which may be a unique hash identifying the particular blockchain operation. Blockchain operation 200 may also include a source field 206 which may indicate an identifier (e.g., a blockchain address) of a cryptography-based storage application that is transferring control to another cryptography-based storage application. The source may be used later in the process to transfer control of the cryptographic tokens back. Target field 209 may store an identifier (e.g., blockchain address) of the cryptography-based storage application to which control of the cryptographic tokens is transferred. Item field 212 may store an item identifier of the item being authenticated. In some embodiments, other data may be added to item field 212.

In some embodiments, one or more flags may be added to item field 212. For example, if a blockchain operation is a request to authenticate an item, a particular flag may be added to the blockchain operation (e.g., within item field 212). For example, the flag may be a string “T/F?” indicating a request for authentication. In some embodiments, blockchain operation 200 may include source address field 215. Source address field 215 may store an IP address associated with the user device transmitted within the blockchain operation to the blockchain node. Source address field 215 may later be used for location detection. Thus, operation detection subsystem 114 may determine, based on a flag within the blockchain operation data, that the first blockchain operation corresponds to a request to authenticate the item associated with the identifier of the item. Other flags may be added to a particular blockchain operation. For example, a transfer flag may be added when an owner requests transfer of the item to another owner. Another example of a flag may be within a response blockchain operation indicating whether the item is authentic (e.g., a “T” or an “F” flag, or another suitable flag).

Operation detection subsystem 114 may retrieve blockchain operation data associated with the first blockchain operation. For example, upon detection of a blockchain operation with a target address of a cryptography-based storage application associated with authentication system 102, operation detection subsystem 114 may identify data within the blockchain operation data associated with the particular blockchain operation (e.g., data illustrated in FIG. 2). In some embodiments, authentication system 102, when polling the blockchain for blockchain operation data, may transmit a request to a blockchain node for blockchain data. The blockchain node may respond back with a full copy of a blockchain. Thus, operation detection subsystem 114 may filter the blockchain data for only relevant data associated with the particular target address (e.g., within a target address field as illustrated in FIG. 2). In some embodiments, the blockchain node may transmit only a portion of the full blockchain (e.g., a particular number of latest blocks). Thus, operation detection subsystem 114 may filter that data.

Once the blockchain operation data is retrieved and/or filtered, operation detection system 114 may pass the data and/or a point to the data to validation subsystem 116. Validation subsystem 116 may include software components, hardware components, or a combination of both. Validation subsystem 116 may extract the identifier of the item from the blockchain operation data. For example, as indicated in FIG. 2, the identifier of the item may be stored in item field 212. Thus, validation subsystem 116 may parse the retrieved blockchain operation data and extract the identifier of the item.

Validation subsystem 116 may then determine, based on the identifier of the item, that the item is authentic. For example, validation subsystem 116 may have access to a database storing item identifiers (e.g., serial numbers) and corresponding data describing the item (e.g., the type of item and/or various other features of the item). Validation subsystem 116 may use the identifier of the item (e.g., the serial number) to search the database for a matching item. If the item is found within the database, validation subsystem 116 may determine that the item is authentic. In some embodiments, the identifier of the item may be a code unique to the item such that the code may enhance the authentication mechanism. For example, a new serial number may be faked based on one or more known other serial numbers of a particular product. Thus, a code may be generated such that the code is unique to a particular item and may be difficult to use to generate authentic codes for other items.

In some embodiments, authentication system 102 may use location data to further confirm authenticity of an item. In particular, each blockchain operation may be associated with a source IP address, which is stored within the blockchain operation. Each IP address is associated with a particular location. Thus, validation subsystem 116 may use the location associated with the IP address in combination with a location stored within a database (e.g., within a database on data node 104) associated with the item to determine authenticity. In particular, validation subsystem 116 may extract, from the blockchain operation data, a first location associated with the first cryptography-based storage application. For example, a user that is attempting to authenticate an item may be in close proximity to the item. Thus, when the user transmits a blockchain operation for authenticating the item, the location of the user's device (e.g., based on the IP address of the user's device as illustrated in FIG. 2) may indicate the location of the item. Thus, validation subsystem 116 may extract the IP address from the blockchain operation and determine a location associated with the blockchain operation.

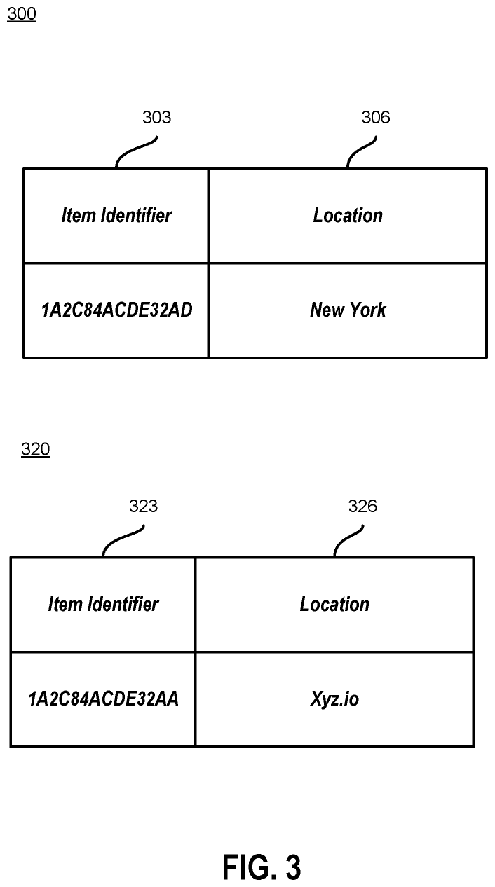

Validation subsystem 116 may also retrieve, based on the identifier of the item, a second location associated with a third cryptography-based storage application of an entity possessing the item. For example, every time ownership of the item changes (e.g., a transfer blockchain operation is detected), validation subsystem 116 may record a change in a database (e.g., database on data node 104). Data structure 300 of FIG. 3 illustrates a location associated with a particular item identifier. Field 303 may store the item identifier while field 306 may store the location of the item. The location may be a city, country, locality, or another suitable location. Validation subsystem 116 may then compare the first location and the second location. Based on determining that the first location matches the second location, validation subsystem 116 may determine that the item is authentic. In some embodiments, the locations may be in different formats. For example, the location of the blockchain operation may be a city while the location within a database may be a state/territory or a county. Thus, locations may match when one location is within another location.

In some embodiments, validation subsystem 116 may additionally or alternatively track virtual location of the item. For example, the distributor or manufacturer of the item may have transferred the item to a particular vendor that has a website on which the item is being sold. The website may also be a decentralized application that is able to read the address of the user's cryptography-based storage application and generate blockchain operations to be executed on a blockchain node against a blockchain. The user may use their client device to connect to the website and before purchasing the item, may attempt to authenticate the item. Thus, the blockchain operation may include a serial number and a virtual location (e.g., in field 212) indicating the website. Validation subsystem 116 may determine a first virtual location associated with the first cryptography-based storage application. As discussed above, the first virtual location may include a first identifier of an Internet-based application or website being accessed by a user.

In addition, validation subsystem 116 may retrieve, based on the identifier of the item, a second virtual location of an entity possessing the item. The second virtual location may include a second identifier of an application (or a website) hosted by the entity. For example, if the distributor that received the item from, for example a manufacturer, owns xyz.io website, authentication system 102 may add that website as a virtual location (e.g., in a database hosted on data node 104). Data structure 320 of FIG. 3 illustrates such a location in combination with the identifier of the item. Thus, data structure 320 may include item identifier field 323 and location field 326. Item identifier field 323 may store the identifier of the item while location field 326 may store a corresponding virtual location.

Validation subsystem 116 may compare the first virtual location and the second virtual location. Based on determining that the first virtual location matches the second virtual location, validation subsystem 116 may determine that the item is authentic. For example, if for a particular identifier of the item a virtual location within a database is xyz.io and the blockchain operation indicates a virtual location as xyz.io (e.g., the user is logged into the xyz.io application or website), validation subsystem 116 may determine that the item is authentic.

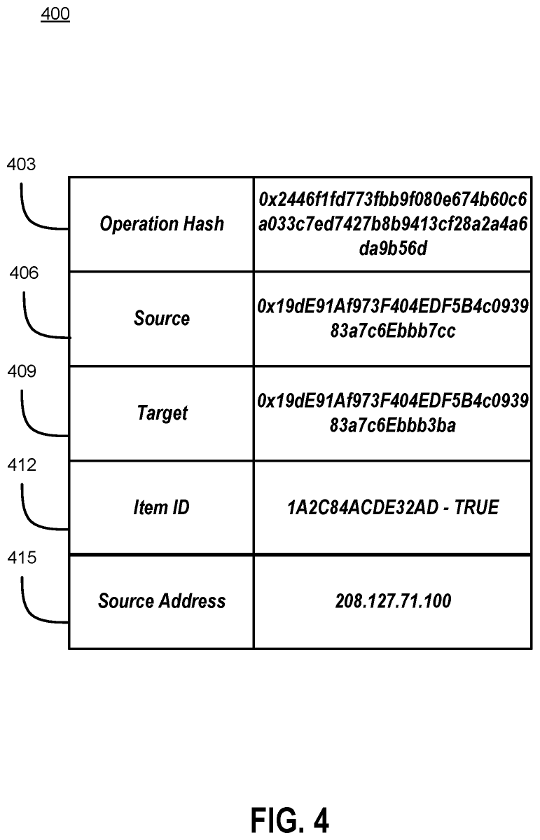

When validation subsystem 116 determines that the item is authentic, validation subsystem 116 may inform the requesting entity by generating and submitting another blockchain operation to the blockchain via the blockchain node. In particular, validation subsystem 116 may generate a second blockchain operation. The second blockchain operation may transfer control of the one or more cryptographic tokens from the second cryptography-based storage application to the first cryptography-based storage application. In addition, the second blockchain operation may store the identifier of the item and an indication that the item is authentic. For example, validation subsystem 116 may build a blockchain operation 400 as illustrated in FIG. 4. Blockchain operation 400 may include operation hash field 403. Operation hash field 403 may include a unique hash identifying the particular blockchain operation. Blockchain operation 400 may also include a source field 406 which may indicate an identifier (e.g., a blockchain address) of a cryptography-based storage application that is transferring control to another cryptography-based storage application. The source field of blockchain operation 400 may be the same as a target field of blockchain operation 200. Target field 409 may store an identifier (e.g., blockchain address) of the cryptography-based storage application to which control of the cryptographic tokens is transferred. The target field of blockchain operation 400 may be the same as a source field of blockchain operation 200. Item field 412 may store an item identifier of the item being authenticated. In addition, field 412 may include a result of authentication. For example, the value “TRUE” or “T” may indicate that the item is authentic while the value “FALSE” or “F” may indicate that the item is not authentic. In some embodiments, other data may be added to item field 412. Source address field 415 may be an IP address of authentication system 102. When the blockchain operation for acknowledging validation is generated, validation subsystem 116 may transmit (e.g., via communication subsystem 112) the second blockchain operation to a blockchain node so that the blockchain operation may be committed to the blockchain.

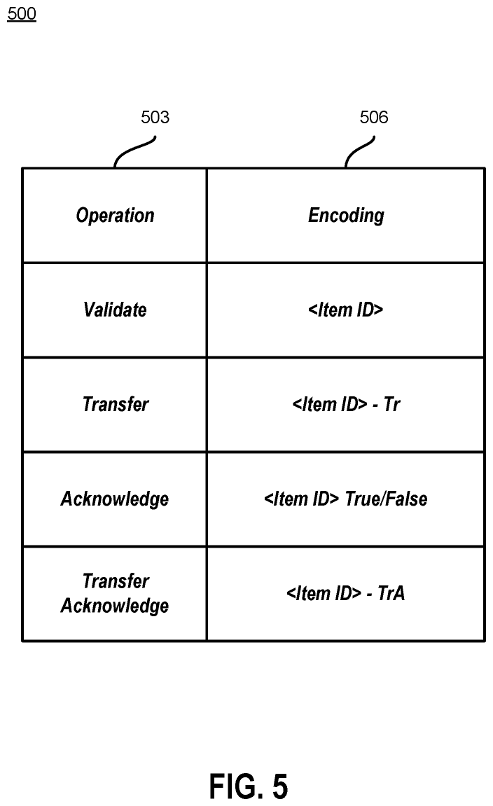

As discussed above, one or more flags may be added to item field 212 or item field 412. For example, authentication system 102 may enable transfer of an item from one owner to another. Transfer may be from a vendor to a user or from one user to another user. Thus, item field 412 may include a flag for transferring an item. FIG. 5 illustrates a table 500 storing some possible flags that may be included in item field 412. Column 503 may store the names of the flags while column 506 may store the encoding of a corresponding flag. A validation flag has been described above in relation to a blockchain operation to authenticate an item. As illustrated in FIG. 5 the validation flag may be an absence of a flag, such that only the identifier of the item is included. The transfer request flag may be indicated by a “Tr” or another suitable string/number together with the identifier of the item and an acknowledge flag may include a True/False indicator or another suitable indicator, as described above. A transfer acknowledge flag may indicate that the transfer request was completed. Other flags or schemes may be used in FIG. 5 to perform validation and/or item transfer.

To transfer an item, authentication system 102 may perform the following operations. Authentication system 102 may detect (e.g., via communication subsystem 112) a third blockchain operation. In some embodiments, authentication system 102 may receive a second notification of a third blockchain operation (e.g., from data node 104 that analyzes and processes blockchain operations). The third blockchain operation may indicate a transfer of the item from an entity to a user, a user to a user, or an entity to an entity. The third blockchain operation may store the identifier of the item and a target cryptography-based storage application. Authentication system 102 may determine, based on a flag associated with the third blockchain operation, that the third blockchain operation corresponds to a request to transfer the item associated with the identifier of the item to the user. As discussed above, the flag may be a “Tr” string within the item field of the blockchain operation. Authentication system 102 may pass the blockchain operation or a pointer to the blockchain operation to transfer subsystem 118. Transfer subsystem 118 may include software components, hardware components, or a combination of both.

Transfer subsystem 118 may receive the blockchain operation as it has been committed to the blockchain, determine whether the transfer is proper (e.g., the owner is asking for a transfer) and then generate another blockchain operation to perform the transfer. For example, the transfer blockchain operation may be received from an address associated with a cryptography-based storage application of the owner of the item. Because each blockchain operation is signed (e.g., using a cryptographic signature) with a private key associated with the corresponding cryptography-based storage application, transfer subsystem 118 may confirm that the cryptographic signature is valid. Transfer subsystem 118 may also determine whether the address or another identifier received as part of the blockchain operation is set as an owner of the item. Thus, transfer subsystem 118 may determine that the entity requesting the transfer is a valid transfer source.

To make this determination, transfer subsystem 118 may retrieve a history associated with the particular identifier of the item. The history may be a history of blockchain operations where the item field includes the particular item identifier. Transfer subsystem 118 may extract, from the blockchain data, a plurality of blockchain operations having the identifier of the item and a transfer acknowledgment flag. Thus, transfer subsystem 118 may filter the history for blockchain operations that include the identifier of the item and also the flag indicating a transfer acknowledgment (e.g., a “TrA” string within the item field). In addition, transfer subsystem 118 may filter out any operations that are not associated with the address of the cryptography-based storage application associated with authentication system 102. That is, any transfer acknowledgment from a different address indicates a fraudulent transfer and will be filtered out. Transfer subsystem 118 may then determine that a last blockchain operation is associated with an address of a cryptography-based storage application of the entity. Based on determining that the last blockchain operation is associated with the address of a cryptography-based storage application of the entity, transfer subsystem 118 may determine that the entity is a valid transfer source. Thus, transfer subsystem 118 may determine the last owner based on the latest transfer in the chain of transfers to authenticate the owner. In some embodiments, transfer subsystem 118 may not transfer the item unless the chain of transfers is unbroken.

When transfer subsystem 118 determines that the transfer may proceed based on a valid transfer request, transfer subsystem 118 may generate a fourth blockchain operation. The fourth blockchain operation may transfer control of the one or more cryptographic tokens to be controlled by the target cryptography-based storage application. For example, the fourth blockchain operation may include a flag indicating a successful transfer (e.g., a “TrA” flag of FIG. 5).

### Computing Environment

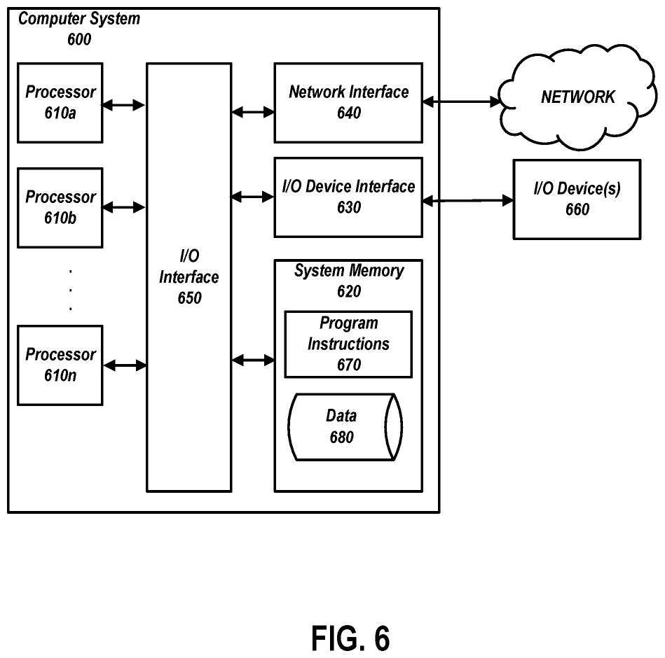

FIG. 6 shows an example computing system that may be used in accordance with some embodiments of this disclosure. In some instances, computing system 600 is referred to as a computer system 600. A person skilled in the art would understand that those terms may be used interchangeably. The components of FIG. 6 may be used to perform some or all operations discussed in relation to FIGS. 1-5. Furthermore, various portions of the systems and methods described herein may include or be executed on one or more computer systems similar to computing system 600. Further, processes and modules described herein may be executed by one or more processing systems similar to that of computing system 600.

Computing system 600 may include one or more processors (e.g., processors 610a-610n) coupled to system memory 620, an input/output (I/O) device interface 630, and a network interface 640 via an I/O interface 650. A processor may include a single processor, or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 600. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 620). Computing system 600 may be a uni-processor system including one processor (e.g., processor 610a), or a multi-processor system including any number of suitable processors (e.g., 610a-610n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field-programmable gate array) or an ASIC (application-specific integrated circuit). Computing system 600 may include a plurality of computing devices (e.g., distributed computer systems) to implement various processing functions.

I/O device interface 630 may provide an interface for connection of one or more I/O devices 660 to computer system 600. I/O devices may include devices that receive input (e.g., from a user) or output information (e.g., to a user). I/O devices 660 may include, for example, a graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 660 may be connected to computer system 600 through a wired or wireless connection. I/O devices 660 may be connected to computer system 600 from a remote location. I/O devices 660 located on remote computer systems, for example, may be connected to computer system 600 via a network and network interface 640.

Network interface 640 may include a network adapter that provides for connection of computer system 600 to a network. Network interface 640 may facilitate data exchange between computer system 600 and other devices connected to the network. Network interface 640 may support wired or wireless communication. The network may include an electronic communication network, such as the Internet, a local area network (LAN), a wide area network (WAN), a cellular communications network, or the like.

System memory 620 may be configured to store program instructions 670 or data 680. Program instructions 670 may be executable by a processor (e.g., one or more of processors 610a-610n) to implement one or more embodiments of the present techniques. Program instructions 670 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one or more computer processors located locally at one site, or distributed across multiple remote sites and interconnected by a communication network.

System memory 620 may include a tangible program carrier having program instructions stored thereon. A tangible program carrier may include a non-transitory computer-readable storage medium. A non-transitory computer-readable storage medium may include a machine-readable storage device, a machine-readable storage substrate, a memory device, or any combination thereof. A non-transitory computer-readable storage medium may include non-volatile memory (e.g., flash memory, ROM, PROM, EPROM, EEPROM memory), volatile memory (e.g., random access memory (RAM), static random-access memory (SRAM), synchronous dynamic RAM (SDRAM)), bulk storage memory (e.g., CD-ROM and/or DVD-ROM, hard drives), or the like. System memory 620 may include a non-transitory computer-readable storage medium that may have program instructions stored thereon that are executable by a computer processor (e.g., one or more of processors 610a-610n) to cause the subject matter and the functional operations described herein. A memory (e.g., system memory 620) may include a single memory device and/or a plurality of memory devices (e.g., distributed memory devices).

I/O interface 650 may be configured to coordinate I/O traffic between processors 610a-610n, system memory 620, network interface 640, I/O devices 660, and/or other peripheral devices. I/O interface 650 may perform protocol, timing, or other data transformations to convert data signals from one component (e.g., system memory 620) into a format suitable for use by another component (e.g., processors 610a-610n). I/O interface 650 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 600, or multiple computer systems 600 configured to host different portions or instances of embodiments. Multiple computer systems 600 may provide for parallel or sequential processing/execution of one or more portions of the techniques described herein.

Those skilled in the art will appreciate that computer system 600 is merely illustrative and is not intended to limit the scope of the techniques described herein. Computer system 600 may include any combination of devices or software that may perform or otherwise provide for the performance of the techniques described herein. For example, computer system 600 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, a Global Positioning System (GPS), or the like. Computer system 600 may also be connected to other devices that are not illustrated, or may operate as a stand-alone system. In addition, the functionality provided by the illustrated components may, in some embodiments, be combined in fewer components, or distributed in additional components. Similarly, in some embodiments, the functionality of some of the illustrated components may not be provided, or other additional functionality may be available.

### Blockchain Environment

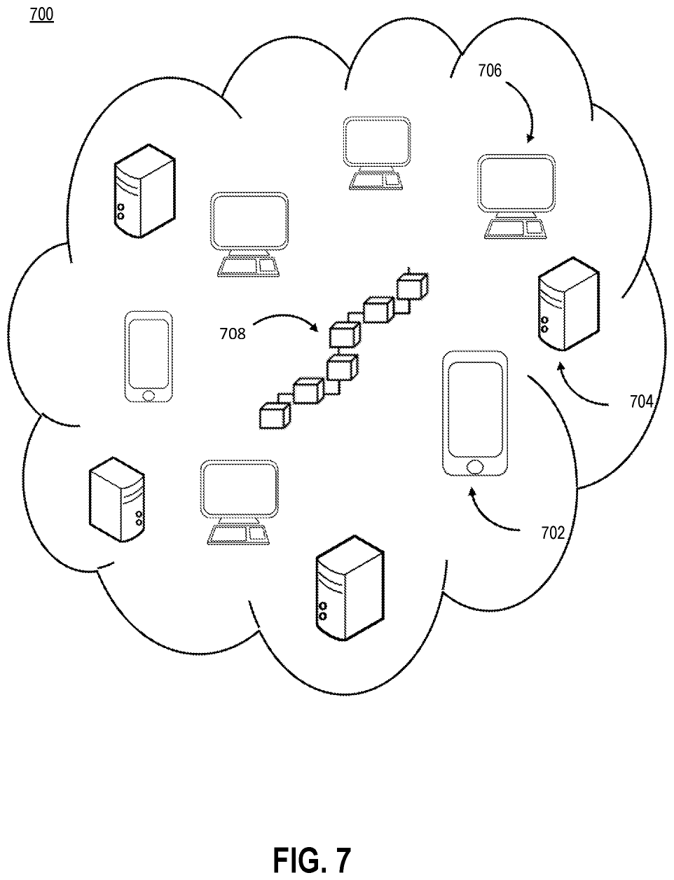

FIG. 7 shows an illustrative diagram for a decentralized environment for performing blockchain functions or operations, in accordance with one or more embodiments. For example, the diagram presents various components that may be used to allocate and distribute cryptographic resources in response to an off-chain trigger or event upon request, in some embodiments.

As shown in FIG. 7, system 700 may include multiple user devices (e.g., user device 702, user device 704, and/or user device 706). For example, system 700 may comprise a distributed state machine, in which each of the components in FIG. 7 acts as a client of system 700. For example, system 700 (as well as other systems described herein) may comprise a large data structure that holds not only all accounts and balances but also a state machine which can change from block to block according to a predefined set of rules and which can execute arbitrary machine code. The specific rules of changing state from block to block may be maintained by a virtual machine (e.g., a computer file implemented on and/or accessible by a user device, which behaves like an actual computer) for the system. For example, system 700 may interact with, and facilitate the function of, blockchain 708.

It should be noted that, while shown as a smartphone, a personal computer, and a server in FIG. 7, the user devices may be any type of computing device, including, but not limited to, a laptop computer, a tablet computer, a hand-held computer, and/or other computing equipment (e.g., a server), including “smart,” wireless, wearable, and/or mobile devices. It should be noted that embodiments describing system 700 performing a blockchain function may equally be applied to, and correspond to, an individual user device (e.g., user device 702, user device 704, and/or user device 706) performing the blockchain function. That is, system 700 may correspond to the user devices (e.g., user device 702, user device 704, and/or user device 706) collectively or individually.

Each of the user devices may be used by the system to conduct blockchain functions or operations and/or contribute to allocating and distributing cryptographic resources in response to an off-chain trigger or event upon request. As referred to herein, “blockchain functions” or “blockchain operations” may comprise any operations including and/or related to blockchains and blockchain technology. For example, blockchain functions or operations may include conducting transactions, querying a distributed ledger, generating additional blocks for a blockchain, transmitting communications-related nonfungible tokens, performing encryption/decryption, exchanging public/private keys, and/or other operations related to blockchains and blockchain technology. In some embodiments, a blockchain function or operation may comprise the creation, modification, detection, and/or execution of a smart contract or program stored on a blockchain. For example, a smart contract may comprise a program stored on a blockchain that is executed (e.g., automatically, without any intermediary's involvement or time loss) when one or more predetermined conditions are met. In some embodiments, a blockchain function may comprise the creation, modification, exchange, and/or review of a token (e.g., a digital blockchain-specific asset), including a nonfungible token. A nonfungible token may comprise a token that is associated with a good, a service, a smart contract, and/or other content that may be verified by, and stored using, blockchain technology.

In some embodiments, blockchain functions or operations may also comprise actions related to mechanisms that facilitate other blockchain functions (e.g., actions related to metering activities for blockchain functions on a given blockchain network). For example, Ethereum, which is an open-source, globally decentralized computing infrastructure that executes smart contracts, uses a blockchain to synchronize and store the system's state changes. Ethereum uses a network-specific cryptocurrency called ether to meter and constrain execution resource costs. The metering mechanism is referred to as “gas.” As the system executes a smart contract, the system accounts for every blockchain function (e.g., computation, data access, transaction, etc.). Each blockchain function has a predetermined cost in units of gas (e.g., as determined based on a predefined set of rules for the system). When a blockchain function triggers the execution of a smart contract, the blockchain function may include an amount of gas that sets the upper limit of what can be consumed in running the smart contract. The system may terminate execution of the smart contract if the amount of gas consumed by computation exceeds the gas available in the blockchain function. For example, in Ethereum, gas comprises a mechanism for enabling Turing-complete computation while limiting the resources that any smart contract and/or blockchain function may consume.

In some embodiments, gas may be obtained as part of a blockchain function or operation (e.g., a purchase) using a network-specific cryptocurrency (e.g., ether in the case of Ethereum). The system may require gas (or the amount of the network-specific cryptocurrency corresponding to the required amount of gas) to be transmitted with the blockchain function as an earmark to the blockchain function. In some embodiments, gas that is earmarked for a blockchain function may be refunded back to the originator of the blockchain function if, after the computation is executed, an amount remains unused.

As shown in FIG. 7, one or more user devices may include a digital wallet (e.g., cryptography-based storage application described above) used to perform blockchain functions or operations. For example, the digital wallet may comprise a repository that allows users to store, manage, and trade their cryptocurrencies and assets, interact with blockchains, and/or conduct blockchain functions using one or more applications. The digital wallet may be specific to a given blockchain protocol or may provide access to multiple blockchain protocols. In some embodiments, the system may use various types of wallets such as hot wallets and cold wallets. Hot wallets are connected to the Internet while cold wallets are not. Most digital wallet holders hold both a hot wallet (e.g., residing on a computing device) and a cold wallet (residing on a device that is generally disconnected from a computing device and is not accessible until connected). Hot wallets are most often used to perform blockchain functions, while a cold wallet is generally used for managing a user account and may have no connection to the Internet.

One or more user devices may include a private key and a public key. In such cases, each pair comprises a public key (e.g., which may be public) and a private key (e.g., which may be kept private). Key pairs may be generated using cryptographic algorithms (e.g., featuring one-way functions). Computing devices may then encrypt a message using an intended receiver's public key such that the encrypted message may be decrypted only with the receiver's corresponding private key. In some embodiments, a message may be used in combination with a private key to create a digital signature on the message. For example, the digital signature may be used to verify the authenticity of blockchain functions or operations. As an illustration, when conducting blockchain functions, the digital signature may be used to prove to every node in the system that it is authorized to conduct the blockchain functions.

For example, system 700 may comprise a plurality of nodes for the blockchain network. A node for a blockchain network may comprise an application or other software that records and/or monitors peer connections to other nodes and/or miners for the blockchain network. For example, a miner comprises a node in a blockchain network that facilitates blockchain functions by verifying blockchain functions or operations on the blockchain, adding new blocks to the existing chain, and/or ensuring that these additions are accurate. The nodes may continually record the state of the blockchain and respond to remote procedure requests for information about the blockchain.

Following an authentication of the blockchain function, the blockchain function may be authorized. For example, after the blockchain function is authenticated between the users, system 700 may authorize the blockchain function prior to adding it to the blockchain. Blockchain function or operations may be added to blockchain 508 via blockchain nodes. The blockchain may perform this (via blockchain nodes) based on a consensus within the blockchain network. For example, system 700 may rely on a majority (or other metric) of the nodes in the community network to determine that the blockchain function or operation is valid. In response to validation of the block, a blockchain node in the community network (e.g., a miner) may receive a reward (e.g., in a given cryptocurrency) as an incentive for validating the block.

To validate the blockchain function, a blockchain node may use one or more validation protocols and/or validation (or consensus) mechanisms. For example, a blockchain node may use a Proof of Work (POW) mechanism in which a user device must provide evidence that it performed computational work to validate a blockchain function, and thus this mechanism provides for achieving consensus in a decentralized manner as well as preventing fraudulent validations. For example, the POW may involve iterations of a hashing algorithm. The user device that is successful aggregates and records blockchain functions from a mempool (e.g., a collection of all valid blockchain functions waiting to be confirmed by the blockchain network) into the next block. Alternatively or additionally, a blockchain node may use a Proof of Stake (POS) mechanism in which a user account (e.g., corresponding to a node on the blockchain network) is required to have, or “stake,” a predetermined amount of tokens in order to be recognized as a validator in the blockchain network. In response to validation of the block, the block is added to blockchain 708, and the blockchain function is completed. For example, to add the blockchain function to blockchain 708, the successful node (e.g., the successful miner) encapsulates the blockchain function in a new block before committing it to the blockchain.

### Operation Flow

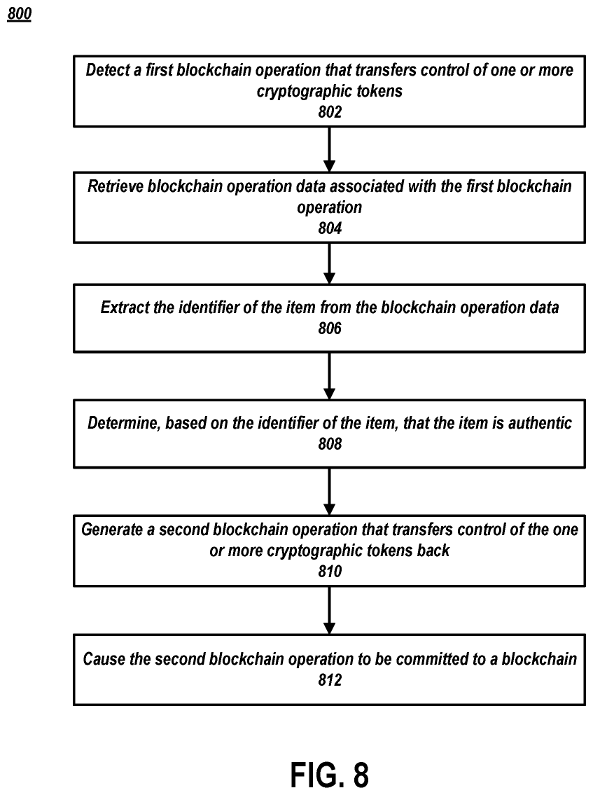

FIG. 8 is a flowchart of operations for verifying authenticity of items using blockchain operations. The operations of FIG. 8 may use components described in relation to FIG. 6 and/or FIG. 7. In some embodiments, authentication system 102 may include one or more components of computer system 600. At 802, authentication system 102 detects a first blockchain operation that transfers control of one or more cryptographic tokens. For example, authentication system 102 may receive, from blockchain 708, one or more blockchain operations (e.g., when new blocks are committed to the blockchain). Authentication system 102 may receive the blockchain operation data using network interface 640 over network 150.

At 804, authentication system 102 retrieves blockchain operation data associated with the first blockchain operation. For example, authentication system 102 may use one or more processors 610a, 610b, and/or 610n to retrieve the data from system memory 620. At 806, authentication system 102 extracts the identifier of the item from the blockchain operation data. For example, authentication system 102 may use one or more processors 610a, 610b, and/or 610n to extract the data from system memory 620.

At 808, authentication system 102 determines, based on the identifier of the item, that the item is authentic. Authentication system 102 may use one or more processors 610a, 610b, and/or 610n to make the determination. At 710, authentication system 102 generates a second blockchain operation that transfers control of the one or more cryptographic tokens back. Authentication system 102 may use one or more processors 610a, 610b, and/or 610n to generate the blockchain operation. At 812, authentication system 102 causes the second blockchain operation to be committed to a blockchain. For example, authentication system 102 may transmit the blockchain operation to a blockchain node (e.g., part of blockchain 708) using network interface 640 over network 150. In some embodiments, authentication system 102 may be a smart contract residing on the blockchain node. Thus, authentication system 102 may instruct the blockchain node to commit the blockchain operation as part of a new blockchain block as discussed in relation to FIG. 7.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method verifying authenticity using blockchain operations, the method comprising: detecting a first blockchain operation that transfers control of one or more cryptographic tokens from a first cryptography-based storage application to a second cryptography-based storage application, wherein the first blockchain operation stores an identifier of an item; retrieving blockchain operation data associated with the first blockchain operation; extracting the identifier of the item from the blockchain operation data; determining, based on the identifier of the item, that the item is authentic; generating a second blockchain operation, wherein the second blockchain operation transfers control of the one or more cryptographic tokens from the second cryptography-based storage application to the first cryptography-based storage application, and wherein the second blockchain operation stores the identifier of the item and an indication that the item is authentic; and transmitting the second blockchain operation to a blockchain node.
2. Any of the preceding embodiments, wherein the first cryptography-based storage application is associated with a client device of a user and the second cryptography-based storage application is associated with a server, and wherein the first blockchain operation stores the identifier of the item for authenticity verification.
3. Any of the preceding embodiments, further comprising determining, based on a flag within the blockchain operation data, that the first blockchain operation corresponds to a request to authenticate the item associated with the identifier of the item.
4. Any of the preceding embodiments, wherein determining that the item is authentic further comprises: extracting, from the blockchain operation data, a first location associated with the first cryptography-based storage application; retrieving, based on the identifier of the item, a second location associated with a third cryptography-based storage application of an entity possessing the item; comparing the first location and the second location; and based on determining that the first location matches the second location, determining that the item is authentic.
5. Any of the preceding embodiments, further comprising: determining a first virtual location associated with the first cryptography-based storage application, wherein the first virtual location comprises a first identifier of an Internet-based application being accessed by a user; retrieving, based on the identifier of the item, a second virtual location of an entity possessing the item, wherein the second virtual location comprises a second identifier of an application hosted by the entity; comparing the first virtual location and the second virtual location; and based on determining that the first virtual location matches the second virtual location, determining that the item is authentic.
6. Any of the preceding embodiments, further comprising: detecting a third blockchain operation, wherein the third blockchain operation indicates a transfer of the item from an entity to a user, and wherein the third blockchain operation stores the identifier of the item and a target cryptography-based storage application; determining that the entity is a valid transfer source; and generating a fourth blockchain operation, wherein the fourth blockchain operation transfers control of the one or more cryptographic tokens to be controlled by the target cryptography-based storage application.
7. Any of the preceding embodiments, further comprising determining, based on a flag associated with the third blockchain operation, that the third blockchain operation corresponds to a request to transfer the item associated with the identifier of the item to the user.
8. Any of the preceding embodiments, wherein determining that the entity is a valid transfer source comprises: extracting, from the blockchain data, a plurality of blockchain operations having the identifier of the item and a transfer acknowledgment flag; determining that a last blockchain operation is associated with an address of a cryptography-based storage application of the entity; and based on determining that the last blockchain operation is associated with the address of a cryptography-based storage application of the entity, determining that the entity is a valid transfer source.
9. A tangible, non-transitory, machine-readable medium storing instructions that, when executed by a data processing apparatus, cause the data processing apparatus to perform operations comprising those of any of embodiments 1-8.
10. A system comprising: one or more processors; and memory storing instructions that, when executed by the processors, cause the processors to effectuate operations comprising those of any of embodiments 1-8.
11. A system comprising means for performing any of embodiments 1-8.
12. A system comprising cloud-based circuitry for performing any of embodiments 1-8.

What is claimed is:

1. A system for verifying authenticity using blockchain operations, the system comprising:
one or more processors; and
a non-transitory computer-readable storage medium storing instructions, which when executed by the one or more processors cause the one or more processors to perform operations comprising:
receiving, at a server, a notification of a first blockchain operation, wherein the first blockchain operation transfers control of one or more cryptographic tokens from a first cryptography-based storage application associated with a client device of a user to a second cryptography-based storage application associated with the server, and wherein the first blockchain operation stores an identifier of an item for authenticity verification;
retrieving, based on the notification from a blockchain node of a blockchain, blockchain operation data associated with the first blockchain operation;
determining, based on a flag within the blockchain operation data, that the first blockchain operation corresponds to a request to authenticate the item associated with the identifier of the item;
extracting the identifier of the item from the blockchain operation data;
determining, based on the identifier of the item and a location recorded within the blockchain operation data, that the item is authentic;
generating a second blockchain operation for the blockchain, wherein the second blockchain operation transfers control of the one or more cryptographic tokens from the second cryptography-based storage application to the first cryptography-based storage application, and wherein the second blockchain operation stores the identifier of the item and an indication that the item is authentic; and
transmitting the second blockchain operation to the blockchain node.

2. The system of claim 1, wherein the instructions for determining that the item is authentic cause the one or more processors to perform operations comprising:
extracting, from the blockchain operation data, a first location associated with the first cryptography-based storage application;
retrieving, based on the identifier of the item, a second location associated with a third cryptography-based storage application of an entity possessing the item;
comparing the first location and the second location; and
based on determining that the first location matches the second location, determining that the item is authentic.

3. The system of claim 1, wherein the instructions further cause the one or more processors to perform operations comprising:
determining a first virtual location associated with the first cryptography-based storage application, wherein the first virtual location comprises a first identifier of an Internet-based application being accessed by the user;
retrieving, based on the identifier of the item, a second virtual location of an entity possessing the item, wherein the second virtual location comprises a second identifier of an application hosted by the entity;
comparing the first virtual location and the second virtual location; and
based on determining that the first virtual location matches the second virtual location, determining that the item is authentic.

4. The system of claim 1, wherein the instructions further cause the one or more processors to perform operations comprising:
receiving a second notification of a third blockchain operation, wherein the third blockchain operation indicates a transfer of the item from an entity to the user, and wherein the third blockchain operation stores the identifier of the item and a target cryptography-based storage application;
determining that the entity is a valid transfer source; and
generating a fourth blockchain operation, wherein the fourth blockchain operation transfers control of the one or more cryptographic tokens to be controlled by the target cryptography-based storage application.

5. A method for verifying authenticity using blockchain operations, the method comprising:
detecting a first blockchain operation that transfers control of one or more cryptographic tokens from a first cryptography-based storage application to a second cryptography-based storage application, wherein the first blockchain operation stores an identifier of an item;
retrieving blockchain operation data associated with the first blockchain operation;
extracting the identifier of the item from the blockchain operation data;
determining, based on the identifier of the item, that the item is authentic;
generating a second blockchain operation, wherein the second blockchain operation transfers control of the one or more cryptographic tokens from the second cryptography-based storage application to the first cryptography-based storage application, and wherein the second blockchain operation stores the identifier of the item and an indication that the item is authentic; and
transmitting the second blockchain operation to a blockchain node.

6. The method of claim 5, wherein the first cryptography-based storage application is associated with a client device of a user and the second cryptography-based storage application is associated with a server, and wherein the first blockchain operation stores the identifier of the item for authenticity verification.

7. The method of claim 5, further comprising determining, based on a flag within the blockchain operation data, that the first blockchain operation corresponds to a request to authenticate the item associated with the identifier of the item.

8. The method of claim 5, wherein determining that the item is authentic further comprises:
extracting, from the blockchain operation data, a first location associated with the first cryptography-based storage application;
retrieving, based on the identifier of the item, a second location associated with a third cryptography-based storage application of an entity possessing the item;
comparing the first location and the second location; and
based on determining that the first location matches the second location, determining that the item is authentic.

9. The method of claim 5, further comprising:
determining a first virtual location associated with the first cryptography-based storage application, wherein the first virtual location comprises a first identifier of an Internet-based application being accessed by a user;
retrieving, based on the identifier of the item, a second virtual location of an entity possessing the item, wherein the second virtual location comprises a second identifier of an application hosted by the entity;
comparing the first virtual location and the second virtual location; and
based on determining that the first virtual location matches the second virtual location, determining that the item is authentic.

10. The method of claim 5, further comprising:
detecting a third blockchain operation, wherein the third blockchain operation indicates a transfer of the item from an entity to a user, and wherein the third blockchain operation stores the identifier of the item and a target cryptography-based storage application;
determining that the entity is a valid transfer source; and
generating a fourth blockchain operation, wherein the fourth blockchain operation transfers control of the one or more cryptographic tokens to be controlled by the target cryptography-based storage application.

11. The method of claim 10, further comprising determining, based on a flag associated with the third blockchain operation, that the third blockchain operation corresponds to a request to transfer the item associated with the identifier of the item to the user.

12. The method of claim 10, wherein determining that the entity is the valid transfer source further comprises:
extracting, from blockchain data, a plurality of blockchain operations having the identifier of the item and a transfer acknowledgment flag;
determining that a last blockchain operation is associated with an address of a cryptography-based storage application of the entity; and
based on determining that the last blockchain operation is associated with the address of the cryptography-based storage application of the entity, determining that the entity is the valid transfer source.

13. A non-transitory, computer-readable storage medium storing instructions that when executed by one or more processors cause the one or more processors to perform operations comprising:
detecting a first blockchain operation that transfers control of one or more cryptographic tokens from a first cryptography-based storage application to a second cryptography-based storage application, wherein the first blockchain operation stores an identifier of an item;
extracting the identifier of the item from the first blockchain operation;
determining, based on the identifier of the item, that the item is authentic;
generating a second blockchain operation, wherein the second blockchain operation transfers control of the one or more cryptographic tokens from the second cryptography-based storage application to the first cryptography-based storage application, and wherein the second blockchain operation stores the identifier of the item and an indication that the item is authentic; and
transmitting the second blockchain operation to a blockchain node.

14. The non-transitory, computer-readable storage medium of claim 13, wherein the first cryptography-based storage application is associated with a client device of a user and the second cryptography-based storage application is associated with a server, and wherein the first blockchain operation stores the identifier of the item for authenticity verification.

15. The non-transitory, computer-readable storage medium of claim 13, wherein the instructions further cause the one or more processors to determine, based on a flag within the first blockchain operation, that the first blockchain operation corresponds to a request to authenticate the item associated with the identifier of the item.

16. The non-transitory, computer-readable storage medium of claim 13, wherein the instructions for determining that the item is authentic further cause the one or more processors to perform operations comprising:
extracting, from the first blockchain operation, a first location associated with the first cryptography-based storage application;
retrieving, based on the identifier of the item, a second location associated with a third cryptography-based storage application of an entity possessing the item;
comparing the first location and the second location; and
based on determining that the first location matches the second location, determining that the item is authentic.

17. The non-transitory, computer-readable storage medium of claim 13, wherein the instructions further cause the one or more processors to perform operations comprising:
determining a first virtual location associated with the first cryptography-based storage application, wherein the first virtual location comprises a first identifier of an Internet-based application being accessed by a user;
retrieving, based on the identifier of the item, a second virtual location of an entity possessing the item, wherein the second virtual location comprises a second identifier of an application hosted by the entity;
comparing the first virtual location and the second virtual location; and
based on determining that the first virtual location matches the second virtual location, determining that the item is authentic.

18. The non-transitory, computer-readable storage medium of claim 13, wherein the instructions further cause the one or more processors to perform operations comprising:
detecting a third blockchain operation, wherein the third blockchain operation indicates a transfer of the item from an entity to a user, and wherein the third blockchain operation stores the identifier of the item and a target cryptography-based storage application;
determining that the entity is a valid transfer source; and
generating a fourth blockchain operation, wherein the fourth blockchain operation transfers control of the one or more cryptographic tokens to be controlled by the target cryptography-based storage application.

19. The non-transitory, computer-readable storage medium of claim 18, wherein the instructions further cause the one or more processors to determine, based on a flag associated with the third blockchain operation, that the third blockchain operation corresponds to a request to transfer the item associated with the identifier of the item to the user.

20. The non-transitory, computer-readable storage medium of claim 18, wherein the instructions for determining that the entity is the valid transfer source further cause the one or more processors to perform operations comprising:
extracting, from blockchain data, a plurality of blockchain operations having the identifier of the item and a transfer acknowledgment flag;
determining that a last blockchain operation is associated with an address of a cryptography-based storage application of the entity; and
based on determining that the last blockchain operation is associated with the address of the cryptography-based storage application of the entity, determining that the entity is the valid transfer source.
